(19) United States
(12) Patent Application Publication
(10) Pub. No.: US 2014/0165366 A1
(43) Pub. Date: Jun. 19, 2014

(54) UNIVERSAL MOUNTING AND SUPPORT SYSTEM FOR ELECTRONIC DEVICES

(71) Applicant: Gary Hochman, Boca Raton (US)

(72) Inventor: Gary Hochman, Boca Raton (US)

(73) Assignee: Quantum Marketing Group LLC, Boca Raton, FL (US)

(21) Appl. No.: 14/111,010

(22) PCT Filed: Apr. 10, 2012
(86) PCT No.: PCT/US2012/032868

§ 371 Date: Nov. 19, 2013

Related U.S. Application Data
(60) Provisional application No. 61/473,994, filed on Apr. 11, 2011.

(51) Int. Cl. F16M 13/00

(52) U.S. Cl. CPC F16M 13/00
USPC 29/525.01; 248/176.1; 248/126

(57) ABSTRACT

A mounting stand for electronic devices has a core spine with front and rear panels. A hinge joining the panels together, allowing the angle between the panels to be adjusted by a user. At least a portion of the front face of the front panel is adapted to mate with an area on the surface of an electronics device to be mounted on the stand such that the device is removably mounted to the stand. Complementary hook-and-loop elements may provide the mating capability. A kit including the mounting stand and one or more accessories may be provided to enhance the usefulness of the stand. The accessories may be devices that allow the stand to be mounted to a variety of objects, and are likewise mateable with the stand.

The present invention relates to a new and improved system for the mounting of objects, and particularly small electronic devices, such as cell phones, tablet computers, and the like.

### BACKGROUND OF THE INVENTION

More and more individuals have and utilize a variety of portable electronic devices in their everyday life. Given the wide variety of situations in which such devices are used, there is a need for a mounting system for such devices that can accommodate a wide variety of such devices and that are usable in a wide variety of settings.

### BRIEF DESCRIPTION OF THE INVENTION

In accordance with the foregoing, the present invention is a universal mounting and support stand comprising a core spine adapted to support and cradle a range of differently-sized electronics devices in a position chosen by the user. The spine may, for example, support the device, such as a cell phone, in a generally upright position on a tabletop or other horizontal surface. The spine is preferable formed such that the angle at which the device is supported or cradled by the spine is adjustable. The spine may be provided with a ledge to support the bottom edge of the cradled device.

The system of the invention further comprises attachments for the spine that further enhance its versatility.

### BRIEF DESCRIPTION OF THE DRAWINGS

A fuller understanding of the present invention will be obtained upon consideration of the following detailed description of preferred but nonetheless illustrative embodiments thereof when reviewed in association with the annexed drawings wherein:

FIG. 1 is a perspective view of the invention;

FIG. 2 is a side elevation view thereof;

FIG. 3 is a plan view of a blank for forming the embodiment of FIG. 1;

FIG. 4 is a perspective view of the invention illustrating the mounting of an electronic device and accessories thereon;

FIG. 5 is an elevation view depicting the use of the invention with an accessory mounting clip;

FIG. 6 is a perspective view depicting use of the invention with accessory mounting straps; and

FIG. 7 is a perspective view of the invention with yet another mounting accessory.

### DETAILED DESCRIPTION OF THE INVENTION

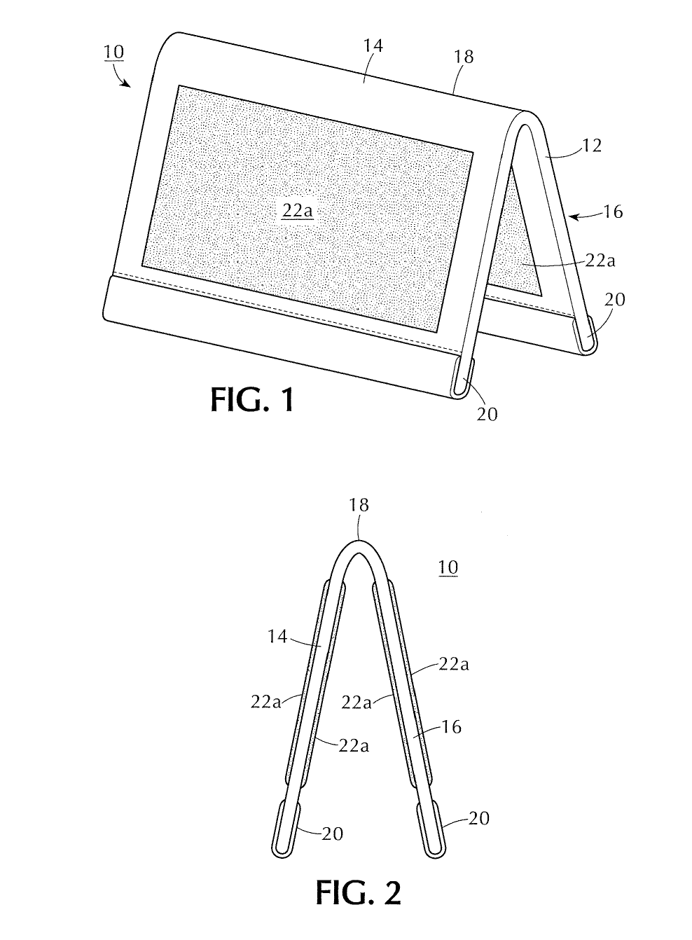

As shown in FIGS. 1 and 2, the inventive mounting stand 10 comprises a core spine 12 shown being in the general form of an inverted “V”, with front and rear panels 14 and 16 respectively joined together along hinge area 18. The core spine may be formed of any appropriate material, such as a malleable metal such as aluminum, or plastic or other synthetic material, and may be formed or cast into a desired angular shape, or provided to be bent by the user. The interior angle between the panels may be between 0 degrees (the panels being essentially parallel to each other) and 180 degrees, depending on the specific application for the stand, as will be further explained herein. Hinge 18 may be integral with the material forming the panels, as shown in the figures, or may be a separate element, whereby panels 14 and 16 are discrete elements mechanically bonded at top edges to the hinge. The hinge, whether integral with or a separate element from the panels, is preferably constructed and adapted to allow the angle between the panels to be adjusted by the user, while maintaining a set angle when in use.

The core spine may be provided with an edging material along the panel lower edges, such as a rubber extrusion having a channel to accept the edge. The edging provides a skid and scrape-free bumper 20 for the mounting stand when placed on a surface in the orientation depicted in the figure. If desired, the bumper edging may likewise extend along the other exposed edges of the panels.

The front face of front panel 14 may be provided with a connector to allow the device to be supported by the stand 10 to be thinly mounted thereto. In a preferred embodiment the connector is a sheet 22a of a first element of a hook-and-loop connector system, such as that sold under the VELCRO brand, a mating element sheet 22b being applied to, for example, the rear surface of the device to be mounted. As known in the art, hook-and-loop sheets are typically provided with an adhesive rear surface to facilitate the application of the sheet elements to the surfaces of the items to be connected together. Other connectors, such as a tackified surface, or mating connectors such as snap systems or other interengaging units, can also be employed. To further enhance the functionality and mounting capabilities of the stand 10, the rear surface of the front panel 16, as well as the surfaces of the rear panel 16, may likewise be provided with connector elements 22a.

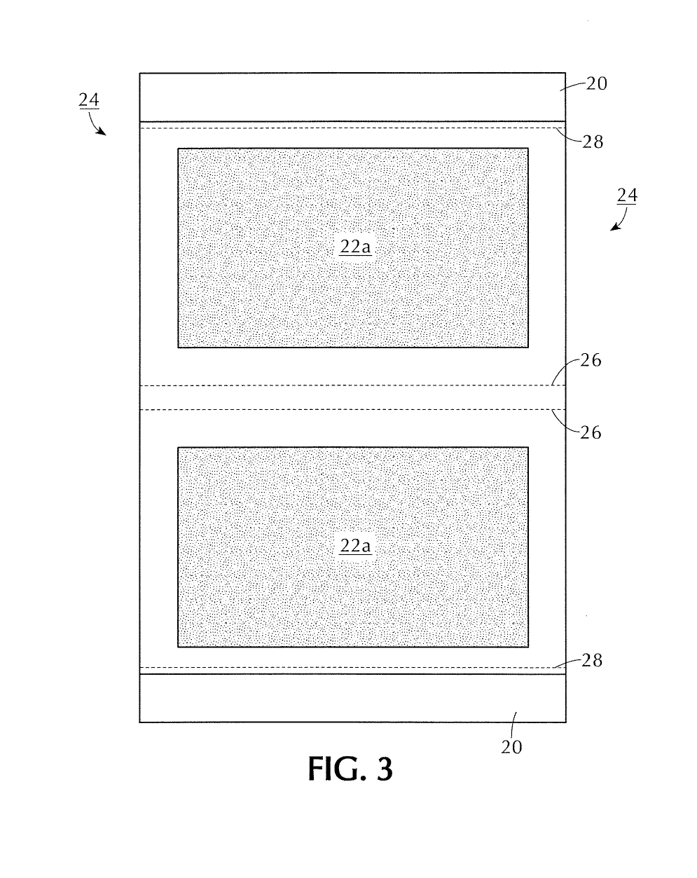

FIG. 3 depicts a plan view of a blank 24, which may be of aluminum, from which the stand 10 of FIGS. 1 and 2 may be formed. Connectors 22a and bumpers 20 are shown applied to the blank. A pair of parallel hinge lines 26 maybe scored into the blank to facilitate the bending of the blank into the inverted V form and to allow further adjustment of the included angle between the panels as may be desired by the user during use. While a single hinge line 26 may be provided, whereby the two panels form a sharply defined angular hinge line, the use of a pair of parallel lines facilitates the creation of a hinge portion having a discrete spacing 40 between the lines, allowing the stand to wrap over, for example, a thin vertically oriented supporting object, such as the top horizontal edge of a cabinet door, the top edge of a golf bag, or the like. In addition, score or fold lines 28 may be provided the bottom edges of the front and rear panels to facilitate the folding or bending of the corresponding edge portion into a ledge to further or alternatively support a device. Alternatively, a bracket may be affixed to one or both of the bottom edges to provide a ledge. In such a case the affixation means for the bracket may provide for the removability of the ledge.

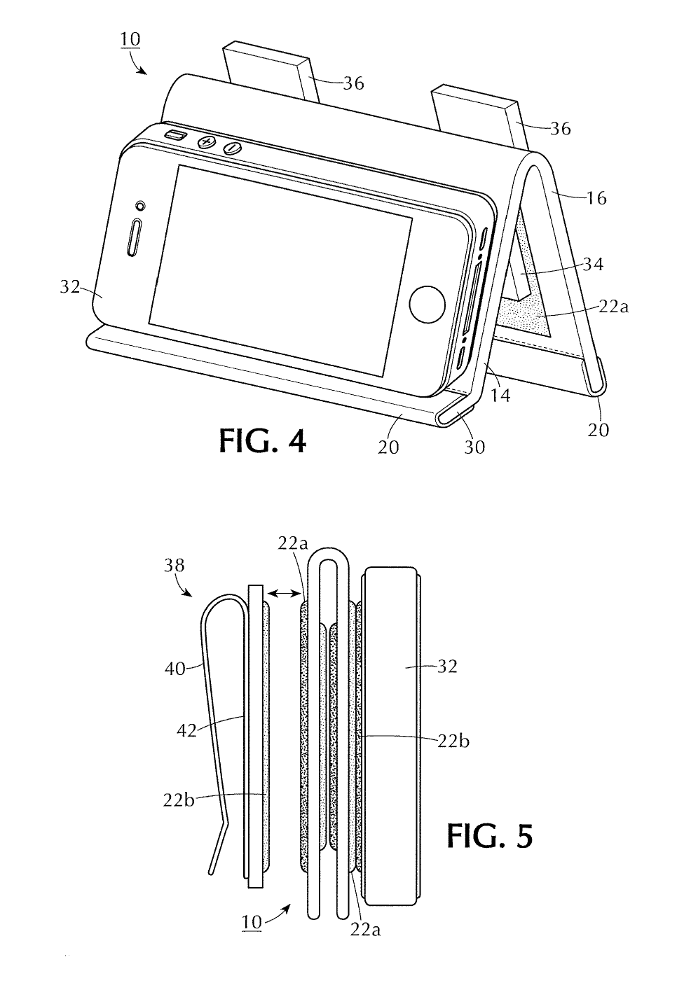

FIG. 4 depicts a stand 10 having the lower edge of the front panel folded to provide a front ledge 30. An electronics device, such a cell phone 32, rests on the ledge. It may additionally be mounted to the panel by the mating connectors 22a, b (not shown). The figure also depicts a first accessory, such as memory module 34, mounted to the inner surface of rear panel 16 by mating connectors 22, and speaker accessories 36 likewise mounted to the outer surface of the rear panel. The angle between the front and rear panels may be adjusted by the user as desired for convenience, the connectors and/or ledge 30 maintaining the mounted devices through the full angular range.

With the front and real panels forming an appropriate included angle, which may be on the order of 30-45 degrees, the stand 10 sits comfortably on a horizontal surface, such as a desk top. By the use of suitable accessories, however, the stand can be used in a wide variety of other orientations and locations.

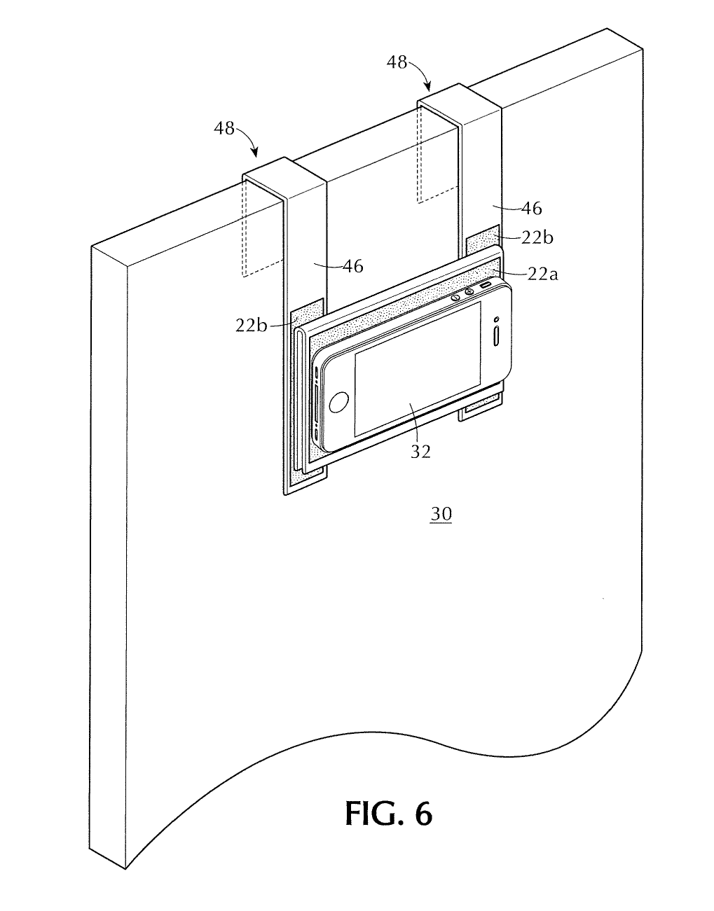

FIG. 5 depicts the combination of the stand 10 and a mounting clip 38 which allows a mounted device, such as cell phone 32, to be supported on and by a variety of panel-like surfaces, such as on an automobile sun visor, a, display stand, easel, or the like. Clip 38 is of conventional construction, having a pair of spaced legs 40, 42 spring biased together by section 44. The spacing of the legs allows the clip to be engaged with an edge portion of an object having a thickness capable of being accommodated between and gripped by the legs 40, 42. The clip is provided with a connector element 22b mateable with the connector element 22a on the rear panel of the stand 10, while an electronics device 32 is likewise mounted to the stand's front panel 14. The electronics device can thus be mounted to any surface capable of accommodating the clip legs 40, 42. While the figure depicts the front and rear panels of the stand in a generally parallel orientation, it is to be appreciated that the angle between the panels may be adjusted as desired to accommodate the needs of the user and the desired orientation of the mounted electronics device.

FIG. 6 depicts the combination of stand 10 with another mounting accessory. In this embodiment, a pair of strap elements 46 are provided, each of the straps being formed of a generally rigid material, such as sheet metal or plastic, with a hook portion 48 foamed at its upper end. The hooks allow the straps wrap around and thus to be supported upon the upper edge of a generally horizontal element, such a vertical panel 50. The front faces of the straps are each again provided with a connector element 22b mateable with the connector element 22a on the rear panel of stand 10, thus allowing the stand 10 and the accommodated electronics device 32 to be supported on the top edge of the panel. The panel may be any of a wide variety of objects, such as a cabinet door, a seat or chair back, or the top of a golf bag.

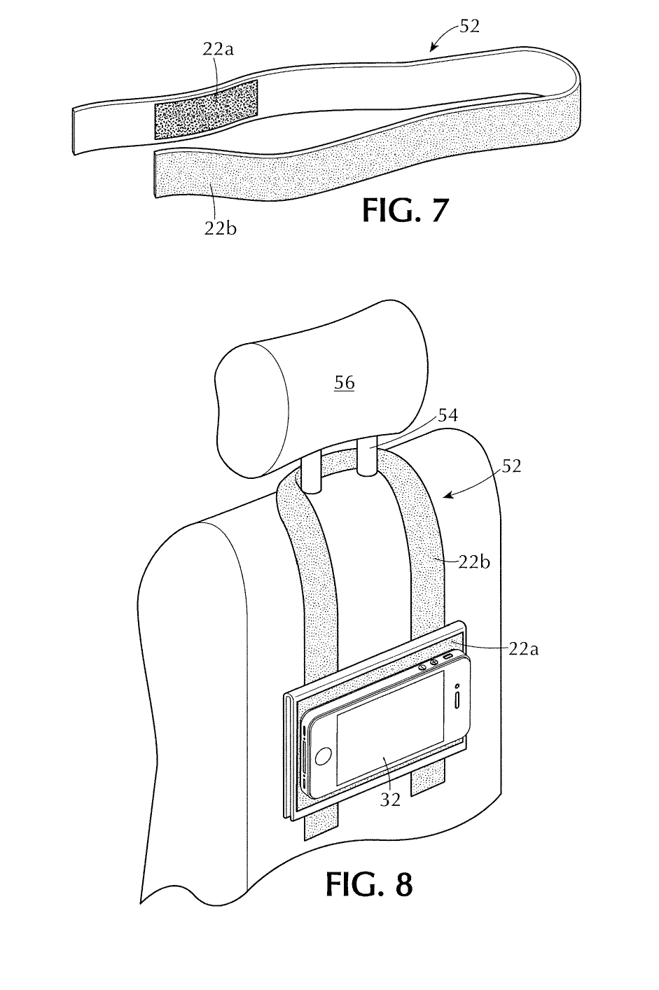

Yet another accessory for the stand 10 to facilitate mounting thereof is depicted in FIGS. 7 and 8. As shown therein, flexible strap 52 has a first surface covered with connector 22b, again mateable with the connector 22a on the stand's rear panel. The strap may be draped about any appropriate object, such as the support posts 54 for an automobile seat headrest 56, and mated with the connector 22a on the stand rear panel to support the stand and the mounted device 32 from the posts. The length of the strap 52 may be varied as desired to allow wrapping about intended support objects. The second surface of the strap may also be provided with one or more sections having connector 22a, allowing the strap to engage with itself, allowing an end the strap, for example, to be wrapped around and secured to an object, such as a pipe, to allow the stand 10 to be supported thereby.

I claim:

1. A mounting stand for electronic devices, comprising a core spine with front and rear panels and a hinge joining the panels together, at least the front panel being adapted and arranged to support an electronics device thereon.

2. The mounting stand of claim 1, wherein a front face of the front panel has connection means mateable with complementary connection means on an electronics device to be mounted on the stand.

3. The mounting stand of claim 1, wherein the hinge is integral with the front and rear panels.

4. The mounting stand of claim 2, wherein the hinge is integral with the front and rear panels.

5. The mounting stand of claim 2 wherein a rear face of the front panel and front and rear faces of the real panel also have the connection means.

6. The mounting stand of claim 2 wherein the connection means is one element of a mateable hook-and-loop connection set.

7. A mounting kit for electronic devices, comprising the mounting stand of claim 2 and a clip having a pair of joined legs adapted to engage an object, the mounting stand further having connection means on a rear face of the rear panel, the clip having connection means complementary to the rear face connection means whereby the mounting stand may be joined to the clip.

8. A mounting kit for electronic devices, comprising the mounting stand of claim 1 and a at least one strap adapted to wrap about at least a portion of a object to which the mounting stand is to be affixed, the mounting stand having connection means on a rear face of the rear panel, the strap having connection means complementary to the rear face connection means whereby the mounting stand may be joined to the strap.

9. The mounting kit of claim 8 wherein the at least one strap is rigid and includes a hook at an end thereof.

10. The mounting kit of claim 8 wherein the at least one strap is flexible.

11. The mounting kit of claim 10 wherein the at least one strap's connection means is on a first face thereof, the at least one strap having further connection means complementary to the connection means on a first face on a second face.

12. A method for supporting an electronics device in a desired position, comprising the steps of:
configuring a stand for the electronics device, the stand having a core spine with hinged front and rear panels such that the panels define a desired interior angle between them;
applying mateable complementary connection means to a front face of the front panel and the electronics device; and
engaging the complementary connection means to mount the electronics device to the stand in a desired orientation.

13. The method of claim 12, further comprising the step of applying mateable complementary connection means to a rear face of the rear panel and a mounting accessory for the stand;
engaging the complementary connection means on the rear face and mounting accessory to connect the stand to the mounting accessory; and
connecting the mounting accessory to a desired object to support the electronics device in the desired position.
